(19) United States
(12) Patent Application Publication
(10) Pub. No.: US 2005/0062835 A1
(43) Pub. Date: Mar. 24, 2005

(54) Light-irradiating device and thermal printer

(75) Inventor: Akira Mizuyoshi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/942,785

(22) Filed: Sep. 17, 2004

(30) Foreign Application Priority Data
Sep. 19, 2003 (JP) 2003-328839

(51) Int. Cl. B41J 11/00; B41J 2/325

(52) U.S. Cl. 347/220

(57) ABSTRACT

A rib is provided at a position to overlap with an alignment surface of LED in a lower surface (front surface) of a paper guide and prevents a color thermal recording paper from adhering to the paper guide caused by static electricity. A recess part having a curved surface corresponding to a projecting surface of the rib is formed on a position corresponding to the rib. The recess part diffuses fixing light emitted from a yellow LED array. The fixing light is irradiated to a recording surface of the color thermal recording paper corresponding to an edge of the rib, so that it is possible to vanish a shadow cast on the recording paper due to the edge so as to prevent fixing unevenness in a width direction of the color thermal recording paper.

### BACKGROUND OF THE INVENTION

1. Field of the Invention

The present invention relates to a light-irradiating device for irradiating light to a sheet member being fed and a thermal printer having an optical fixer for fixing a thermal recording paper by irradiating a fixing light thereto.

2. Description of the Prior Arts

A thermal printer is provided with an optical fixer as a light-irradiating device for fixing a thermally recorded image onto a thermal recording paper with irradiated light. As the light source, in addition to a fluorescent lamp, alight-emitting element array in which a large number of light-emitting elements are arranged linearly is used. Both the light-emitting element array and the fluorescent lamp are arranged so that their longitudinal directions extend along a width direction of the thermal recording paper, and the length of them is determined in accordance with the width of the thermal recording paper. For example, an optical fixation is performed by irradiating the light to the entire recording area while feeding the thermal recording paper in a direction (sub-scanning direction) crosswise to its width direction (main-scanning direction).

In the thermal printer disclosed in Japanese Patent Laid-Open Publication H6-155777, a transparent paper guide for transmitting the fixing light is provided between the optical fixer and the feeding path of the thermal recording paper, so that it is possible to prevent paper jamming and abnormal coloration. The paper jamming occurs when the front end of the thermal recording paper enters into the opening of the reflector of the optical fixer; while the abnormal coloration occurs by exposing the thermal recording paper to the high heat generated from the fixing light source. However, there is a problem that the thermal recording paper adheres to the paper guide due to static electricity caused by friction between the paper guide and the thermal recording paper. In order to solve such problem, there is a paper guide in which a rib projecting toward a recording surface of the recording paper is formed on a surface facing the thermal recording paper. The contact area between the paper guide and the thermal recording paper becomes small by forming the projecting rib, so that the adhering caused by the static electricity can be prevented.

However, since the light emitted from the light-emitting element array is less divergent than that from the fluorescent lamp, if the light-emitting element array is used as the light source, a shadow is cast on the recording surface of the thermal recording paper corresponding to the projecting rib, so that a light emitting amount of the fixing light is varied in the width direction of the thermal recording paper. Therefore, there arises a problem in that fixing unevenness occurs.

### SUMMARY OF THE INVENTION

An object of the present invention is to provide a light-irradiating device in which it is possible to prevent a sheet member from adhering to a transparent paper guide and to reduce variation of a light emitting amount in a width direction of the sheet member.

Another object of the present invention is to provide a thermal printer in which it is possible to prevent adhesion of a thermal recording paper and to reduce fixing unevenness in a width direction of the thermal recording paper by using the above-mentioned light-irradiating device as an optical fixer.

In order to achieve the above objects, a light-irradiating device of the present invention includes a light-emitting element array in which plural light-emitting elements are arranged, and a light-emitting apparatus for irradiating light toward a sheet member, and a guide member which is disposed between the light-emitting element array and a feeding path of the sheet member and is formed by a transparent body for transmitting the light emitted from the light-emitting apparatus. A rib projecting toward the feeding path is formed at a position to overlap with the light-emitting element array on a first surface of the feeding path side of the guide member. The projecting rib prevents the sheet member from adhering to the guide member due to static electricity. In addition, a peripheral part of the rib is deformed in order to vanish a shadow caused by an edge of the rib. Instead of deforming the peripheral part, the rib may be formed on a position to overlap with an area between the two light-emitting elements adjoining in the width direction of the sheet member.

According to the preferred embodiment of the present invention, the thermal printer includes a thermal head for color-recording an image by heating the thermal recording paper, an optical fixer having a light-emitting array in which plural light-emitting elements are arranged so as to irradiate fixing light toward the thermal recording paper with thermally recorded, and a paper guide which is disposed between the light-emitting element array and the feeding path of the thermal recording paper, and is made of a transparent material for transmitting the fixing light. A rib projecting toward the feeding path is formed at a position to overlap with the light-emitting element array on a first surface in the feeding path side of the paper guide. The projecting rib prevents the thermal recording paper from adhering to the paper guide due to static electricity. In addition, a peripheral part of the rib is deformed in order to vanish a shadow caused by an edge of the rib.

In order to deform the peripheral part of the rib, it is preferable to form a curved concave part on a second surface in an opposite side of the first surface of the paper guide so as to overlap with the rib. A lens unit for focusing part of the fixing light toward the rib may be formed on the second surface of the paper guide overlapping with the rib. It is preferable to provide a pair of the lens units in a position to overlap with edges of the both sides of the each rib. Additionally, at least one reflection surface for reflecting the fixing light, which has been already reflected on the thermal recording paper, may be formed on the edge of the rib.

Instead of deforming the peripheral part, the arrangement of the rib may be changed. It is possible to vanish the shadow caused by the edge of the rib by way of providing the rib in a position to overlap with an area between the two light-emitting elements adjoining in the width direction of the thermal recording paper. It is preferable that an interval between the two light-emitting elements on both sides of the rib is narrower than an interval between the other light-emitting elements in the width direction.

It may be provided on the optical fixer that a first light-emitting element array overlapping with the rib and a second light-emitting element not overlapping with the rib. In this case, the light-emitting elements on the first light-emitting element array are disposed to shift a half-cycle against the light-emitting elements on the second light-emitting element array, so that it is possible to prevent the light amount from decreasing due to the rib. Moreover, on the second light-emitting element array, light-emitting intensity of the light-emitting element overlapping with the rib in the width direction is preferably higher than that of the light-emitting elements not overlapping with the rib.

According to the present invention, it is possible to prevent the light emitting amount of the fixing light from decreasing due to the edge of the rib by providing the rib for preventing the thermal recording paper from adhering to the paper guide due to the static electricity, by deforming the peripheral part of the rib, or by optimizing the arrangement of the rib. Accordingly, the fixing unevenness in the width direction of the thermal recording paper can be prevented.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a schematic view showing a structure of a color thermal printer to which the present invention is applied;

FIG. 2 is a bottom view of an optical fixer;

FIG. 3 is a side view of a paper guide wherein a recess part is formed in response to a rib;

FIG. 4 is a side view of a paper guide wherein a projecting part constituting a lens surface is formed in response to a rib;

FIG. 5 is a side view of a paper guide wherein plural projecting parts are formed on a position corresponding to both edges of each rib;

FIG. 6 is a side view of a paper guide wherein plural reflection surfaces are formed on a position corresponding to both edges of each rib;

FIG. 7 is an explanatory view showing an example that the ribs are formed between LEDs aligned in a main-scanning direction;

FIG. 8 is an analogous view to FIG.7 wherein an alignment pitch of the respective LEDs in which the rib exists in between is narrow; and

FIG. 9 is an explanatory view showing an example that light-emitting intensity of the LED located on a position of overlapping with the rib in the main-scanning direction is high.

### DETAILED DESCRIPTION OF THE PREFERRED EMBODIMENTS

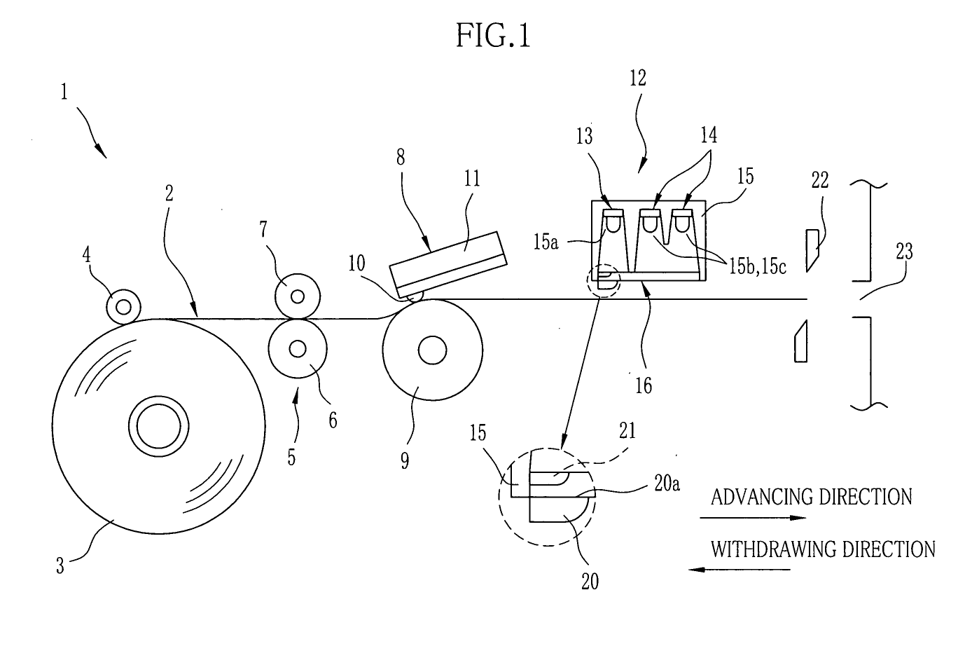

As shown in FIG. 1, in a color thermal printer 1, a long color thermal recording paper 2 is used as a recording media. The color thermal recording paper 2 is wound into a roll shape and loaded into the color thermal printer 1 as a recording paper roll 3.

A feeder roller 4 is in contact with an outer periphery of the recording paper roll 3 and driven by a feeding motor (not shown). When the feeder roller 4 rotates in a counter clockwise direction in the drawing, the recording paper roll 3 is rotated in a clockwise direction in the drawing, and then the color thermal recording paper 2 is fed from the recording paper roll 3. Meanwhile, when the feeder roller 4 rotates in the clockwise direction in the drawing, the recording paper roll 3 is rotated in the counter clockwise direction in the drawing, and then the color thermal recording paper 2 is withdrawn to the recording paper roll 3.

A feeder roller pair 5 for nipping and conveying the color thermal recording paper 2 is disposed adjacent to the recording paper roll 3. The feeder roller pair 5 is constituted of a capstan roller 6 rotated by the feeding motor (not shown) and a pinch roller 7 pressed against the capstan roller 6. The feeder roller pair 5 is rotated with nipping the color thermal recording paper 2, so that the color thermal recording paper 2 is reciprocally fed in an advancing direction toward the right side of the drawing and in a withdrawing direction toward the left side of the drawing.

As is well known, the color thermal recording paper 2 includes a cyan thermosensitive coloring layer, a magenta thermosensitive coloring layer, and a yellow thermosensitive coloring layer overlaid on a support in sequence. The yellow thermosensitive coloring layer, which is the farthest from the support, has the highest heat sensitivity and develops the yellow color by application of relatively low heat energy. The cyan thermosensitive coloring layer, which is the closest to the support, has the lowest heat sensitivity and develops the cyan color by application of relatively high heat energy. The yellow thermosensitive coloring layer loses its coloring ability when near-ultraviolet rays of a wavelength peaking at 420 nm are applied thereto. The magenta thermosensitive coloring layer develops the magenta color with heat energy in between for coloring the yellow and cyan thermosensitive coloring layers, and loses its coloring ability when ultraviolet rays of a wavelength peaking at 365 nm are applied thereto.

A thermal head 8 and a platen roller 9 are disposed on the downstream side of the feeder roller pair 5 so as to hold a feeding path for the color thermal recording paper 2 in between. The thermal head 8, which is disposed above the feeding path of the color thermal recording paper 2, has a heating element array 10 including a large number of heating elements arranged linearly in a main scanning direction. The heating element array 10 generates heat energy in response to pixel density. A radiator plate 11 for cooling the thermal head 8 is attached to an upper part of the thermal head 8.

The platen roller 9 is disposed under the feeding path in opposition to the heating element array 10. The platen roller 9 can move up and down by a shifting mechanism such as a cam and a solenoid, and is biased against the thermal head 8 by a spring (not shown). The platen roller 9 moves downward by the shifting mechanism at the time of feeding or discharging the recording paper, so that an interspace is formed between the platen roller 9 and the thermal head 8.

When the color thermal recording paper 2 is fed by the feeder roller pair 5 in the advancing direction, the thermal head 8 presses the color thermal recording paper 2 against the platen roller 9 and heats each thermo sensitive coloring layer by the heating element array 10 to record each image of yellow, magenta and cyan thereon. The platen roller 9 is rotated in accordance with the feeding of the color thermal recording paper 2.

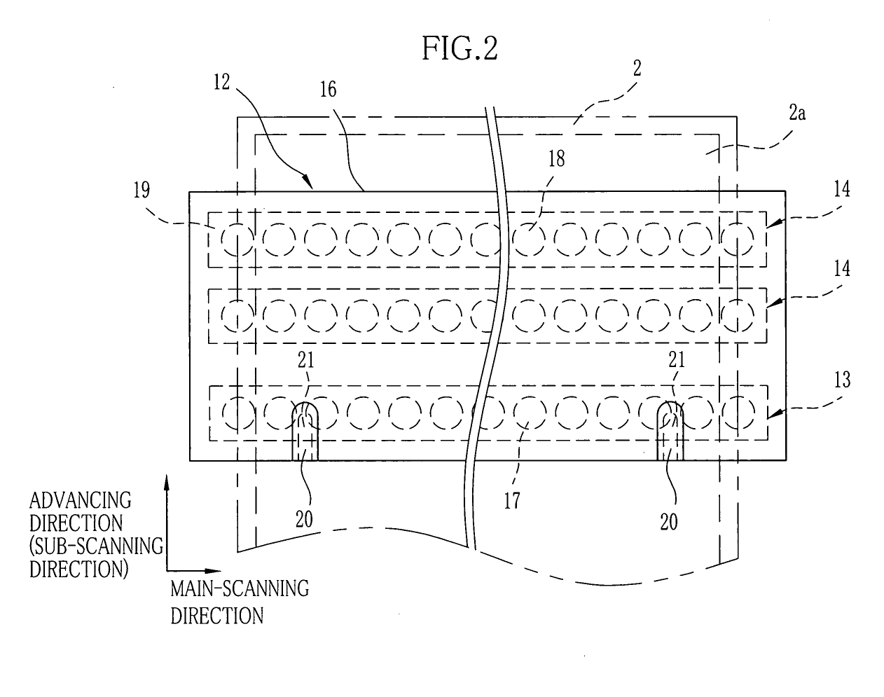

An optical fixer 12 as a fixing light source is disposed on the downstream side from the thermal head 8 in the advancing direction. When the color thermal recording paper 2 is fed by the feeder roller pair 5 in the advancing direction, the optical fixer 12 is operated to fix the image of each color by irradiating the fixing light corresponding to each thermo sensitive coloring layer to entire recording area 2a (see FIG. 2) of the color thermal recording paper 2.

The optical fixer 12 is constituted of a light emitting element array for yellow (yellow LED array) 13, a light emitting element array for magenta (magenta LED array) 14, an attachment stage 15 and a paper guide 16. As shown in FIG. 2, the LED arrays 13, 14 respectively include yellow and magenta light emitting elements (LED (light emitting diode)) 17, 18 aligned linearly on a board 19. For example, one line of the yellow LED 17 and two lines of the magenta LED 18 are provided in the optical fixer 12. The optical fixer 12 is disposed so that the longitudinal direction of the LED arrays 13, 14 corresponds to the main-scanning direction.

The yellow LED 17 emits yellow fixing light which is near-ultraviolet rays of a wavelength peaking at 420 nm, while the magenta LED 18 emits magenta fixing light which is near-ultraviolet rays of a wavelength peaking at 365 nm. As the LEDs 17, 18, a chip-shaped LED without a lead section for wire connection is used, for example, to emit the fixing light from a surface (top surface) facing the color thermal recording paper 2 and a side surface thereof.

The attachment stage 15 is made of metal with high heat-radiating property such as aluminum, and has an attachment surface provided with grooves 15a-15c which take approximately T-shape in the sub-scanning direction. The LED arrays 13, 14 are respectively disposed on a bottom surface of the each groove by one line.

The planar size of the paper guide 16 is the same as the size of an opening of the attachment stage 15, so that the opening is covered by the paper guide 16. As a material for the paper guide 16, a transparent acrylic plate is used for example to transmit the fixing light emitted from the LED arrays 13, 14 through the paper guide 16. The paper guide 16 prevents the color thermal recording paper 2 from entering into the opening when the color thermal recording paper 2 passes through the optical fixer 12, and, in addition, guides the color thermal recording paper 2.

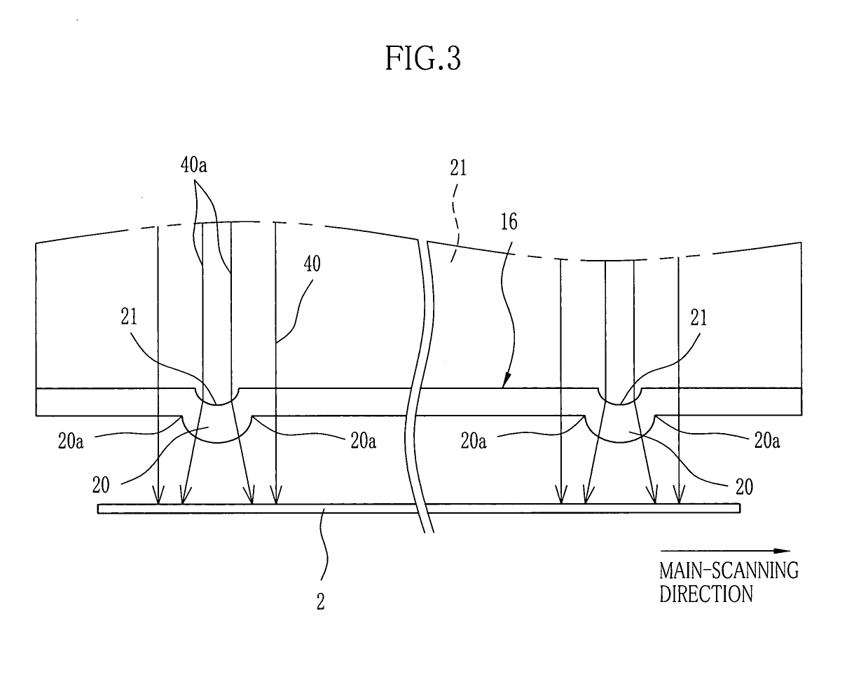

As shown in FIG.3, a rib 20 projecting toward a recording surface of the color thermal recording paper 2 is provided at a position to overlap with an alignment surface of the yellow LED 17 on a lower surface (front surface) of the paper guide 16. In order to transmit the fixing light, the rib 20 is made of transparent acrylic for example, as well as the paper guide 16. The contact area between the paper guide 16 and the color thermal recording paper 2 becomes small by providing the rib 20. Thereby, the static electricity caused by friction between the color thermal recording paper 2 and the paper guide 16 is reduced, so that it is possible to prevent the color thermal recording paper 2 from adhering to the paper guide 16.

A recess part 21 is formed in a position corresponding to each rib 20 on the upper surface (rear surface) of the paper guide 16. The recess part 21 having a curved surface corresponding to a projecting surface of the rib 20 diffuses the light emitted from the yellow LED array 13. As aforementioned, if the rib 20 is provided, there has been a problem that the shadow is cast on the recording surface corresponding to the edge 20a. As the color thermal recording paper 2 is fixed while it is fed, the shadow streaks the recording surface in the sub-scanning direction. The recess part 21 diffuses the fixing light from the rib 20 to vanish the shadow on the color thermal recording paper 2 caused by the edge 20a so as to prevent the fixing unevenness in the main-scanning direction.

In FIG. 1, a cutter 22 and an exit opening 23 are disposed on the downstream side from the optical fixer 12 in the advancing direction. The cutter 22 is operated to cut the color thermal recording paper 2 at a predetermined position. The color thermal recording paper 2 with the image recorded is discharged from the exit opening 23.

Next, the operation of the above embodiment is explained. As shown in FIG. 1, when a short printing operation is performed in the color thermal printer 1, the color thermal recording paper 2 is fed on the feeding path by the rotation of the feeder roller 4. When a front end of the recording area 2a of the color thermal recording paper 2 reaches the heating element array 10 of the thermal head 8, the yellow image is recorded by the thermal head 8.

After the yellow image recording, the color thermal recording paper 2 is fed in sequence toward the yellow LED array 13 of the optical fixer 12, and then the image is fixed thereto. As shown in FIG. 3, fixing light 40, 40a is irradiated to the recording surface of the color thermal recording paper 2 through the paper guide 16, in which the recess part 21 is formed at a position corresponding to the rib 20 in the upper surface (rear surface). Thereby, the shadow caused by the edge 20a of the rib 20 is vanished, so that the fixing unevenness in the width direction of the color thermal recording paper 2 can be prevented.

After the yellow image fixing, the color thermal recording paper 2 is withdrawn to a print-starting position, and then the magenta image is recorded. Subsequently, the color thermal recording paper 2 with the magenta image recorded is fed in sequence toward the magenta LED array 14 of the optical fixer 12 to fix the magenta thermosensitive coloring layer. Thereafter, the color thermal recording paper 2 is withdrawn again to record the cyan image. The color thermal recording paper 2 after the cyan image fixing is cut by the cutter 22 to be discharged from the exiting opening 23.

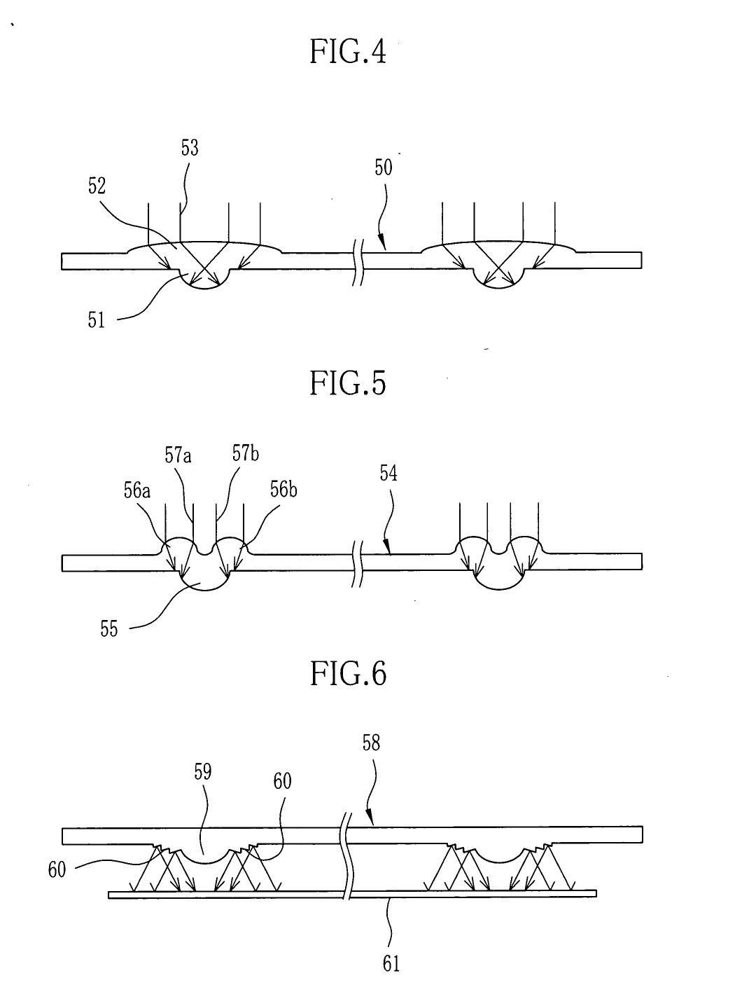

In the above embodiment, the reduced light caused by the edge 20a is complemented by forming the recess part 21 on the upper surface (rear surface) of the paper guide 16. However, as shown in FIG. 4, a projecting part 52 constituting a lens surface may be formed instead of the recess part 21. Fixing light 53 entered into the projecting part 52 is focused toward a rib 51. Thereby, the reduced light caused by edges of the rib 51 is complemented, so that the shadow on the recording surface is vanished. As shown in FIG. 5, projecting parts 56a, 56b having the lens surface may be formed in the positions corresponding to the both edges of a projecting surface of the rib 55. In this embodiment, since the fixing light 57a, 57b entered into the projecting parts 56a, 56b are focused on around the both edges of the rib 51, it is possible to prevent the fixing unevenness caused by the insufficient emitting light amount.

In the example shown in FIG. 6, plural reflection surfaces 60 are formed on edges on both sides of a projecting surface of a rib 59. The reflection surface 60 reflects the light, which has been already reflected on the recording surface of a color thermal recording paper 61, toward the recording surface again. Thereby, the reduced light caused by the both edges of the rib 59 is complemented.

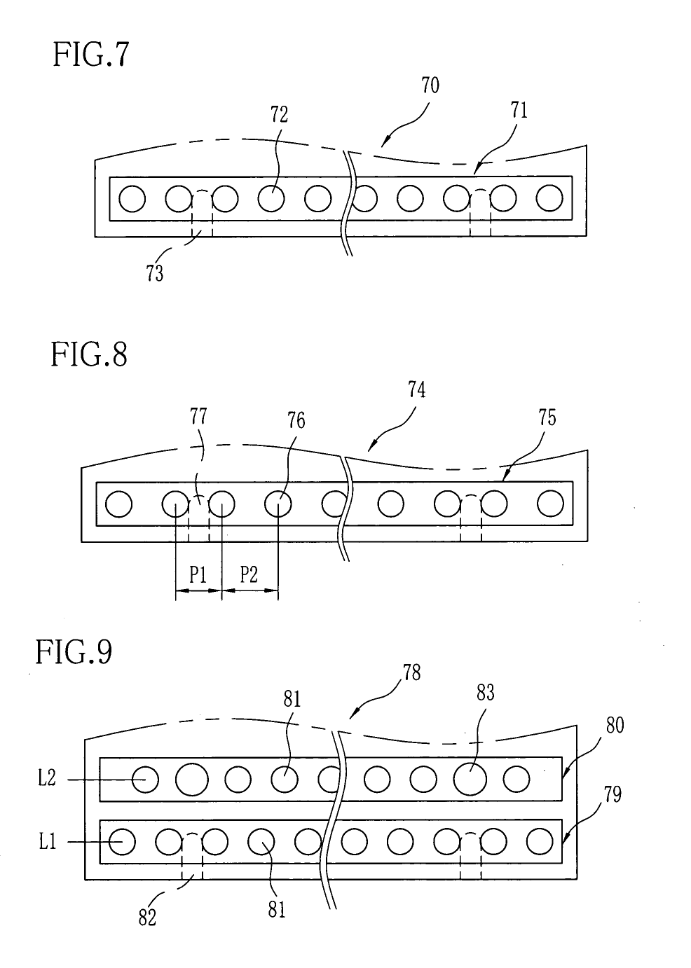

In the examples shown in FIG. 3-FIG. 6, the peripheral part of the rib is deformed; however, the arrangement of the LED in an alignment line facing the rib may be changed. In an optical fixer 70 shown in FIG. 7, a rib 73 is disposed between adjacent LEDs 72 in a LED array 71. Since the light amount of the fixing light decreases between the LEDs 72, the center of the rib 73 is determined there, so that the influence of the reduced light caused by the rib 73 can be lowered in comparison with the case in which the LED 72 and the rib 73 are faced with each other.

Even if the rib 73 is disposed between the two adjacent LEDs 72, it does not always cope with the reduced light caused by the rib 73 completely. In this case, as shown in FIG. 8, an interval P1 between LEDs 76 on both sides of a rib 77 may be narrowed against an interval P2 between the LEDs 76 where the rib 77 does not exist in between. The light emitting amount around the rib 77 increases by narrowing the interval P1, so that it is possible to offset the reduced light caused by the rib 77.

In addition, an optical fixer 78 shown in FIG.9 includes alignment lines L1, L2 on which an alignment pitch of LEDs 81 is constant. The alignment lines L1, L2 are disposed to shift with each other by a half pitch in the main-scanning direction. Therefore, the reduced light between the LEDs 81 on the alignment lines L1, L2 is complemented with each other. Moreover, in addition to dispose a rib 82 between the LEDs 81 on the alignment line L1, it is preferable to raise the light-emitting intensity of an LED 83 on the alignment line L2 overlapping with the position of the rib 82 in the main-scanning direction. As a result, the reduced light caused by the rib 82 is offset. In the present embodiment, the respective alignment pitches of the LED 81 are the same on both alignment lines L1, L2; however, as shown in FIG. 8, the alignment pitch of the LEDs corresponding to the rib may be narrow.

In the above embodiment, although the chip-shaped LED is used in the LED array, the LED array may be formed by mounting a LED with a lead wire on a board.

In the above embodiment, the LED is used as the light-emitting element; however, instead of the LED, various light-emitting elements may be used, including EL (electro-luminescence) and a semiconductor laser element which emits the light from a surface thereof.

In the above embodiment, although the thermal printer is explained as the example, the present invention may be applied to a reading light source for a facsimile machine having the light emitting element, and for a paper-feeding type scanner. For example, if the present invention is applied to the reading light source for the paper-feeding type scanner, it is possible to prevent the paper adhering due to the static electricity between the paper guide and a manuscript, while it prevents the insufficient light amount caused by the edge of the rib.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A thermal printer including a thermal head for color-recording an image by heating a thermal recording paper, an optical fixer having a light-emitting element array in which plural light-emitting elements are arranged so as to irradiate fixing light toward said thermal recording paper with thermally recorded, and a paper guide which is disposed between said light-emitting element array and a feeding path of said thermal recording paper and is made of a transparent material for transmitting said fixing light, said paper guide having a first surface facing said feeding path, said thermal printer comprising:
a rib projecting toward said feeding path and formed at a position to overlap with said light-emitting element array on said first surface of said paper guide, said rib preventing said thermal recording paper from adhering to said paper guide by static electricity, a peripheral part of said rib being deformed in order to vanish a shadow caused by an edge of said rib.

2. A thermal printer as claimed in claim 1, wherein a curved concave part is formed on a second surface in an opposite side of said first surface of said paper guide, said concave part is located so as to overlap with said rib.

3. A thermal printer as claimed in claim 1, wherein a lens unit for focusing part of said fixing light toward said rib is formed on a second surface in an opposite side of said first surface of said paper guide, said lens unit is located so as to overlap with said rib.

4. A thermal printer as claimed in claim 3, wherein a pair of said lens units corresponding to each of said rib is formed, said pair of lens units is located so as to overlap with said edges on both sides of said rib corresponding thereto.

5. A thermal printer as claimed in claim 1, wherein at least one reflection surface is formed on said edge of said rib for reflecting said fixing light, which has been already reflected on said thermal recording paper, toward said thermal recording paper again.

6. A thermal printer including a thermal head for color-recording an image by heating a thermal recording paper, an optical fixer having a light-emitting element array in which plural light-emitting elements are arranged along a width direction of said thermal recording paper so as to irradiate fixing light toward said thermal recording paper with thermally recorded, and a paper guide which is disposed between said light-emitting element array and a feeding path of said thermal recording paper and is made of a transparent material for transmitting said fixing light, said paper guide having a first surface facing said feeding path, said thermal printer comprising:
a rib projecting toward said feeding path and formed on said first surface of said paper guide, said rib preventing said thermal recording paper from adhering to said paper guide by static electricity, said rib being located so as to overlap with an area between the two adjacent light-emitting elements in said width direction in order to vanish a shadow caused by an edge of said rib.

7. A thermal printer as claimed in claim 6, wherein an interval between the two light-emitting elements on both sides of said rib is narrower than an interval between the other light-emitting elements in said width direction.

8. A thermal printer as claimed in claim 6, wherein said optical fixer includes a first light-emitting element array overlapping with said rib and a second light-emitting element array not over lapping with said rib, said light-emitting elements on said first light-emitting element array is disposed to shift about a half cycle against said light-emitting elements on said second light-emitting element array.

9. A thermal printer as claimed in claim 8, wherein light-emitting intensity of said light-emitting element overlapping with said rib in said width direction is higher than the light-emitting intensity of the other light-emitting elements on said second light-emitting array.

10. A light-irradiating device including a light-emitting element array in which plural light-emitting elements are arranged, a light-emitting apparatus irradiating light toward a sheet member and made of a transparent material for transmitting the light from said light-emitting apparatus, and a guide member disposed between said light-emitting element array and a feeding path of said sheet member, said guide member having a first surface facing said feeding path, said light-irradiating device comprising:
a rib projecting toward said feeding path and formed at a position to overlap with said light-emitting element array on said first surface of said guide member, said rib preventing said sheet member from adhering to said guide member by static electricity, a peripheral part of said rib being deformed in order to vanish a shadow caused by an edge of said rib.

11. A light-irradiating device as claimed in claim 10, wherein a curved concave part is formed on a second surface in an opposite side of said first surface of said guide member, said concave part is located so as to overlap with said rib.

12. A light-irradiating device as claimed in claim 10, wherein a lens unit for focusing part of said fixing light toward said rib is formed on a second surface in an opposite side of said first surface of said guide member, said lens unit is located so as to overlap with said rib.

13. A light-irradiating device as claimed in claim 12, wherein a pair of said lens units corresponding to each of said rib is formed, said pair of lens unit is located so as to overlap with said edges on both sides of said rib corresponding thereto.

14. A light-irradiating device as claimed in claim 10, wherein at least one reflection surface is formed on said edge of said rib for reflecting said fixing light, which has been already reflected on said sheet member, toward said sheet member again.

15. A light-irradiating device including a light-emitting element array in which plural light-emitting elements are arranged in a width direction of said sheet member, a light-emitting apparatus for irradiating light toward said sheet member, and a guide member disposed between said light-emitting element array and a feeding path of said sheet member, and made of a transparent material for transmitting the light from said light-emitting apparatus, said guide member having a first surface facing said feeding path, said light-irradiating device comprising:
a rib projecting toward said feeding path and formed on said first surface of said guide member, said rib preventing said sheet member from adhering to said guide member by static electricity, said rib being located so as to overlap with an area between the two adjacent light-emitting elements in said width direction in order to vanish a shadow caused by an edge of said rib.

16. A light-irradiating device as claimed in claim 15, wherein an interval between the two light-emitting elements on both sides of said rib is narrower than an interval between the other light-emitting elements in said width direction.

17. A light-irradiating device as claimed in claim 15, wherein said light-emitting apparatus includes a first light-emitting element array overlapping with said rib and a second light-emitting element array not overlapping with said rib, said light-emitting elements on said first light-emitting element array is disposed to shift about a half cycle against said light-emitting elements on said second light-emitting element array.

18. A light-irradiating device as claimed in claim 17, wherein light-emitting intensity of said light-emitting element overlapping with said rib in said width direction is higher than the light-emitting intensity of the other light-emitting elements on said second light-emitting element array.
